(19) United States
(12) Patent Application Publication
(10) Pub. No.: US 2026/0044937 A1
(43) Pub. Date: Feb. 12, 2026

(54) EFFECTIVE IMAGE PROCESSING USING NEURAL NETWORK

(71) Applicant: Varjo Technologies Oy, Helsinki (FI)

(72) Inventor: Mikko Ollila, Tampere (FI)

(73) Assignee: Varjo Technologies Oy, Helsinki (FI)

(21) Appl. No.: 18/798,150

(22) Filed: Aug. 8, 2024

(51) Int. Cl. G06T 5/60; G06T 7/10

(52) U.S. Cl. CPC G06T 5/60; G06T 7/10; G06T 2207/20081

(57) ABSTRACT

A computer-implemented method includes utilising an analysis neural network to select a first image processing filter from amongst a plurality of image processing filters that is to be applied to a given part of an input image, wherein the analysis neural network is trained to select an image processing filter having a minimum loss for the given part of the input image as the first image processing filter, wherein respective first image processing filters are selected for different parts of the input image; and applying the respective first image processing filters to the different parts of the input image.

### TECHNICAL FIELD

The present disclosure relates to computer-implemented methods incorporating effective image processing using neural networks. Moreover, the present disclosure relates to systems incorporating effective image processing using neural networks.

### BACKGROUND

Nowadays, with an increase in the number of images being captured every day, there is an increased demand for developments in image processing techniques. Such a demand is quite high and critical in case of evolving technologies such as immersive extended-reality (XR) technologies which are being employed in various fields such as entertainment, real estate, training, medical imaging operations, simulators, navigation, and the like.

As the captured images are extremely prone to introduction of various types of visual artifacts such as a blur, a noise, or similar therein, such images are generally not used, for example, to display to users directly or to create the XR environments. Since the human visual system is very sensitive to detecting such visual artifacts, when said captured images are displayed directly to a given user, the given user will easily notice a lack of sharpness, visual cues, a presence of noise, and the like, both in a gaze region and a peripheral region within his/her field of view. This leads to a poor visual experience, making the captured images unsuitable for direct display or for creating high-quality XR environments. Moreover, such visual artifacts also adversely affect image aesthetics, which is undesirable when creating the XR environments.

However, existing image processing techniques have several limitations associated therewith. Firstly, the existing image processing techniques often employ several different neural networks for applying different image enhancement operations and/or image restoration operations to correct different artifacts present in an image. In such a case, a training of the several different neural networks becomes complex, cumbersome, time-consuming and processing-resource intensive. Moreover, employing two or more neural networks in a cascade manner, is also inefficient because not all the different artifacts that the two or more neural networks are designed to correct, may be present in every other image. As a result, employing the two or more neural networks in the cascade manner is often unnecessary and wasteful. Moreover, this often results in a decline in a frame rate of generating output images (upon correcting said images). Secondly, the existing image processing techniques often only focus on improving an image quality of a gaze region or a peripheral region of an image. Due to this, an output image does not have a high visual quality (for example, in terms of a high resolution) throughout its field of view, and it often has visual artifacts such as flying pixels (i.e., random isolated pixels that appear to fly across said image) due to un-distortion or noise, differences in brightness across said image, and the like. This often leads to a sub-optimal (i.e., a lack of realism), non-immersive viewing experience for a user viewing such output images.

Therefore, in light of the foregoing discussion, there exists a need to overcome the aforementioned drawbacks.

### SUMMARY

The present disclosure seeks to provide a method and a system for improving a visual quality of input images (namely, for correcting the input images) by way of applying image processing filters using an analysis neural network, in a computationally-efficient and a time-efficient manner. The present disclosure also seeks to provide a method which facilitates a simple, yet accurate and reliable way to train the analysis neural network to select image processing filters having a minimum loss for parts of the input images. The aim of the present disclosure is achieved by methods and a system incorporating effective image processing using an analysis neural network, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a method incorporating effective image processing using a neural network, in accordance with a first aspect of the present disclosure;

FIG. 2 illustrates steps of a method incorporating effective image processing using a neural network, in accordance with a second aspect of the present disclosure;

FIG. 3 illustrates a block diagram of an architecture of a system incorporating effective image processing using a neural network, in accordance with a third aspect of the present disclosure;

FIGS. 4A and 4B illustrate different regions of an input image, in accordance with different embodiments of the present disclosure;

FIG. 5 illustrates an input image being divided into a plurality of image segments, in accordance with an embodiment of the present disclosure

FIGS. 6A, 6B, and 6C illustrate different exemplary scenarios of generating different output images by utilising an analysis neural network, respectively, in accordance with an embodiment of the present disclosure; and

FIG. 7 illustrates an exemplary pair of a ground-truth image and a defective image that is utilised for training a given neural network, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a computer-implemented method comprising:
utilising an analysis neural network to select a first image processing filter from amongst a plurality of image processing filters that is to be applied to a given part of an input image, wherein the analysis neural network is trained to select an image processing filter having a minimum loss for the given part of the input image as the first image processing filter, wherein respective first image processing filters are selected for different parts of the input image; and
applying the respective first image processing filters to the different parts of the input image.

In a second aspect, an embodiment of the present disclosure provides a computer-implemented method comprising:
training a plurality of neural networks to apply respective ones of a plurality of image processing filters to images, wherein a given neural network corresponding to a given image processing filter is trained using a set of pairs of ground-truth images and corresponding defective images; and
training an analysis neural network using at least a subset of said set, along with weights and biases that are learnt during the training of the given neural network, wherein the analysis neural network is trained using at least subsets of respective sets used for training the plurality of neural networks, along with respective weights and biases that are learnt during the training of the plurality of neural networks, further wherein the analysis neural network is trained to select an image processing filter from amongst the plurality of image processing filters that has a minimum loss for a given part of an input image, for applying to the given part of the input image.

In a third aspect, an embodiment of the present disclosure provides a system comprising:
a data storage for storing an analysis neural network; and
at least one processor configured to:
   utilise the analysis neural network to select a first image processing filter from amongst a plurality of image processing filters that is to be applied to a given part of an input image, wherein the analysis neural network is trained to select an image processing filter having a minimum loss for the given part of the input image as the first image processing filter, wherein respective first image processing filters are selected for different parts of the input image; and
   apply the respective first image processing filters to the different parts of the input image.

The present disclosure provides the aforementioned method of the first aspect and the aforementioned system of the third aspect for improving a visual quality of the input image (namely, for correcting the input image) by way of applying the respective first image processing filters to the different parts of the input image using the analysis neural network, for generating an output image, in a computationally-efficient and a time-efficient manner. The present disclosure also provides the aforementioned method of the second aspect which facilitates a simple, yet accurate and reliable way to train the analysis neural network to select the respective first image processing filters having a minimum loss for the different parts of the input image. Herein, when the input image is provided as an input to the analysis neural network, the analysis neural network analyses the input image, and optionally, identifies at least one defect (for example, such as a high noise, a motion blur, a defocus blur, a low brightness, and the like) in the given part of the given image, irrespective of whether the given part belongs to a gaze region or a peripheral region. Once the at least one defect is identified, the analysis neural network selects the given image processing filter from amongst the plurality of image processing filters which has the minimum loss for the given part of the given image. Upon such a selection, the analysis neural network applies the given image processing filter to the given part of the given image. Beneficially, a selection of the image processing filter having the minimal loss for the given part of the given image would ensure that the given part of the given image is well-corrected for any defect, when the image processing filter is applied thereat. By selecting and applying only necessary image processing filter(s), the system avoids a diminishing return associated with employing excessive, unnecessary image processing filter(s), as beyond a certain point, additional image processing filters do not contribute to further improvements in an image quality of the image. This is because a specific defect that is being corrected is either not present in the image or already adequately corrected via other image processing filter that was previously applied. Such a selective approach not only conserves computational resources of the at least one processor, but also reduces an overall processing time of the at least one processor, without compromising on the image quality of the image. As a result, the output image is highly accurately and realistically generated (i.e., without any defects or with negligible defects that would be imperceptible/unnoticeable to the at least one user). Upon said generation, the output image is optionally displayed to at least one user, via at least one display, or is optionally utilised for creating an extended-reality (XR) environment. The methods and the system are also susceptible to cope with visual quality requirements, for example, such as a high resolution (such as a resolution higher than or equal to 60 pixels per degree), whilst achieving a high frame rate (such as a frame rate higher than or equal to 90 frames per second (FPS)). The methods and the system are simple, robust, fast, reliable, support real-time effective image processing using the analysis neural network, and can be implemented with ease.

Notably, the at least one processor controls an overall operation of the system. The at least one processor is communicably coupled to at least the data storage. Optionally, the at least one processor is implemented as a processor of a computing device. Examples of the computing device include, but are not limited to, a laptop, a desktop, a tablet, a phablet, and a console. Alternatively, optionally, the at least one processor is implemented as a cloud server (namely, a remote server) that provides a cloud computing service.

Throughout the present disclosure the term “analysis neural network” refers to a type of a neural network that is capable of analysing a given image to select a given image processing filter to be applied to a given part of the given image. In other words, the analysis neural network is utilised to analyse the given image to ascertain which type of image processing filters could be applied to different parts of the given image, in order to improve an overall visual quality (for example, such as in terms of at least one of: a brightness, a contrast, a sharpness, a resolution) of the given image. Notably, in this regard, an input of the analysis neural network comprises the input image. It is to be noted that the analysis neural network would be utilised for the aforesaid selection of the given image processing filter for the given part of the given image during an inference phase of the analysis neural network (namely, after a training phase of the analysis neural network, i.e., when the analysis neural network has been trained). It will be appreciated that the (trained) analysis neural network is stored in the data storage that is communicably coupled to the at least one processor. Examples of the data storage include, but are not limited to, a memory of the at least one processor, a memory of the computing device, a removable memory, and a cloud-based database. The term “given image” encompasses at least the input image, while the term “given image processing filter” encompasses at least the first image processing filter.

Optionally, the analysis neural network is a convolutional neural network (CNN), a U-net type neural network, an autoencoder, a Residual Neural Network (ResNet), a Vision Transformer (ViT), a neural network having self-attention layers, a generative adversarial network (GAN), a deep unfolding-type (namely, deep unrolling-type) neural network. It will be appreciated that the CNN is typically effective in extracting multiple features from an image for analysing different parts of the image, and in understanding a context/need to select appropriate image processing filter(s) from the plurality of image processing filter for the different parts of the image. Moreover, due to a convolutional structure the CNN, the CNN could easily and accurately analyse said image in real-time or near-real time, with minimal computational resources. All the aforementioned types of analysis neural networks are well-known in the art. It will be appreciated that two or more of the aforementioned types of analysis neural networks could also be employed in a parallel or a series combination.

Throughout the present disclosure, the term “image” refers to a visual representation of a real-world environment, which encompasses not only colour information represented in the image, but also other attributes (for example, such as depth information, transparency information, luminance information, brightness information, and the like) associated with the image. Throughout the present disclosure, the term “input image” refers to an image that is provided as an input to the analysis neural network, said image having at least one defect. The at least one defect (namely, a visual anomaly or a visual artifact) could, for example, be a high noise (for example, such as a high shot noise and/or a high gaussian noise), a motion blur, a defocus blur, a low brightness, a low contrast, a low sharpness, an occlusion, an obliteration, a distortion, an oversaturation, an undersaturation, an underexposure, an overexposure, a low resolution, and the like.

Throughout the present disclosure the term “image processing filter” refers to a filter that is when applied to a given part of a given image having the at least one defect, improves a visual quality of the given part of the given image. Said visual quality could be improved (namely, enhanced), for example, such as in terms of at least one of: a brightness, a contrast, a sharpness, a resolution, of the given part of the given image. It is to be understood that when a given image processing filter is applied to the given part of the given image, pixel values of pixels belonging to the given part of the given image are modified (namely, increased or decreased) accordingly, in order to achieve an intended effect of the given image processing filter on the given part of the given image (namely, to improve the visual quality of said part of the given image).

The term “image processing filters” may encompass image enhancement filters and image restoration filters. Examples of the plurality of image processing filters include, but are not limited to, a smoothing filter, a defocus deblurring filter, a motion deblurring filter, a denoising filter, a text enhancement filter, an edge enhancement filter, a contrast enhancement filter, a colour enhancement filter, a sharpening filter, a colour conversion filter, an high-dynamic range (HDR) filter, an object detection-based enhancement filter, a style transfer filter, an auto white-balancing filter, a low-light enhancement filter, a tone mapping filter, an inpainting filter, a distortion correction filter, an exposure-correction filter, a saturation-correction filter, and a super-resolution filter. All the aforementioned image processing filters, image enhancement filters, and image restoration filters are well-known in the art. It will be appreciated that some image processing filters may also be capable of correcting more than one defect such as both a noise and a motion blur, in an image. Moreover, the denoising filter may be applied based on at least one of: whether objects represented in the given image has a texture or no texture, a type of noise (such as a shot noise, a Gaussian noise, or the like) in the given image, a degree of the noise in the given image.

Optionally, different parts of the given image could be in a form of any one of: different individual pixels of the given image, different regions of the given image, different image segments of the given image. Optionally, the different regions of the given image comprise a gaze region and a peripheral region surrounding the gaze region. Optionally, the different regions of the given image further comprises an intermediate region lying between the gaze region and the peripheral region. Information pertaining to the gaze region and the peripheral region has been discussed later in detail.

It will be appreciated that, optionally, when analysing the given image, the analysis neural network identifies the at least one defect in the given part of the given image. Once the at least one defect is identified, the analysis neural network selects the given image processing filter from amongst the plurality of image processing filters which has the minimum loss for the given part of the given image, based on the at least one defect. Upon such a selection, the analysis neural network applies the given image processing filter to the given part of the given image. When the given image is the input image, the analysis neural network applies the respective first image processing filters to the different parts of the input image, to generate the output image. Upon said generation, the output image is optionally displayed to at least one user, via at least one display. Throughout the present disclosure, the term “output image” refers to an image that is generated upon applying respective image processing filters to different parts of the given image.

Throughout the present disclosure, the term “minimum loss” refers to a minimum error between a visual quality of a given part of an output image and a visual quality of a corresponding part of a ground-truth image. The minimum loss is measured by employing a loss function (as discussed later in detail). An aim of the (trained) analysis neural network is to generate output images that are as accurate and realistic as corresponding ground-truth images. Beneficially, a selection of the image processing filter having the minimal loss for the given part of the given image would ensure that the given part of the given image is well-corrected for any defect, when the image processing filter is applied thereat. As a result, the output image is highly accurately and realistically generated (i.e., without any defects or with negligible defects that would be imperceptible/unnoticeable to the at least one user), in a computationally-efficient and a time-efficient manner.

In some implementations, the different parts of the given image may have a same defect and a degree of the same defect may be same across the different parts of the given image. In such a case, a same first image processing filter could be selected to be applied uniformly to an entirety of the input image. For example, when the entirety of the input image has a uniform defocus blur, a defocus deblurring filter may be applied uniformly to the entirety of the input image. In other implementations, the different parts of the input image may have a same defect, but the degree of the same defect may vary across the different parts of the input image. In such a case, a same first image processing filter could be selected to be applied adaptively to the different parts of the input image. In other words, the same first image processing filter of varying strengths may be applied to the different parts of the input image, based on the degree of the same defect in the given part of the input image.

It will be appreciated that only some of the different parts of the given image may have defects, while a remainder of the different parts of the given image may not have any defects. In such a case, the respective first image processing filters would only be applied to some of the different parts of the given image, while no image processing filters would be applied to the remainder of the different parts of the given image (in other words, the remainder of the different parts of the given image would remain as-it-is), to generate the output image. This may potentially save processing resources and a processing time of the at least one processor. Moreover, this facilitates in achieving an overall improved image quality in the output image, as only those parts of the given image that are actually defective, are corrected in the output image. However, in some scenarios, the remainder of the different parts of the given image may also have defects, but the remainder of the different parts belong to the peripheral region (described below) of the given image. In such scenarios, it may not be necessary or beneficial to apply any image processing filters to the remainder of the different parts of the given image. This may be because the peripheral region comprises non-gaze-continent objects, which are not perceived with a higher visual acuity by a fovea of a user's eye, as compared to gaze-continent objects in the gaze region (described below) of the given image, when the output image is displayed to the user. It will be appreciated that, due to this, a number of image processing filters that could be applied to the peripheral region may be less, as compared to a number of image processing filters that could be applied to the gaze region.

Optionally, the respective first image processing filters are applied to the different parts of the input image, to generate an intermediate image, the method further comprising:
utilising the analysis neural network to select a second image processing filter from amongst the plurality of image processing filters that is to be applied to a given part of the intermediate image, wherein the analysis neural network is trained to select an image processing filter having a minimum loss for the given part of the intermediate image as the second image processing filter, wherein respective second image processing filters are selected for different parts of the intermediate image; and
applying the respective second image processing filters to the different parts of the intermediate image, to generate an output image.

In this regard, there may be a scenario where at least two different defects are present in the input image. In such a case, the respective first image processing filters are selected (by the analysis neural network) corresponding to one of the at least two different defects, to be applied to the different parts of the input image, to generate the intermediate image. In this way, the one of the at least two different defects is mitigated (i.e., corrected) in the input image, and the (generated) intermediate image would have another of the at least two different defects. Therefore, the respective second image processing filters are selected (by the analysis neural network) corresponding to the another of the at least two different defects, to be applied to the different parts of the intermediate image, to generate the output image. Advantageously, in this way, the output image is highly accurately and realistically generated (i.e., without any defects or with negligible defects that would be imperceptible/unnoticeable to the at least one user), even when several different defects are present in the input image. In other words, generating the intermediate image subsequently facilitates in correcting the several different defects which could be present in the input image. The term “intermediate image” refers to an image that is generated upon applying the respective first image processing filters to the different parts of the input image, and that is provided as the input to the analysis neural network, for further processing.

It will be appreciated that all the different parts of the input image need not necessarily have the at least two different defects. In other words, when the at least two different defects comprise a first defect and a second defect, the given part of the input image may have at least one of: the first defect, the second defect. Similarly, when the (generated) intermediate image would have another of the at least two different defects, it need not necessarily mean that all the different parts of the intermediate image have the another of the at least two different defects. In other words, only some parts the intermediate image may have defect(s), just like in a case of the input image as described above. Furthermore, the given part of the intermediate image need not necessarily correspond to the given part of the input image. For example, the given part of the input image may be a given pixel of the input image, whereas the given part of the intermediate image may be a given region of the intermediate image. It will also be appreciated that when more than two different defects are present in the input image, the analysis neural network may generate more than one intermediate image, i.e., there may be two or more additional iterations of applying further image processing filters to different parts of the more than one intermediate image, to generate the output image. Optionally, when the intermediate image is provided as the input to the analysis neural network to generate the output image, the input further comprises information pertaining to the different parts of the input image and the respective first image processing filters that are applied to the different parts of the input image. In an example, upon analysing the input image, the different parts of the input image may have two defects, namely, a defocus blur and a noise. For mitigating the defocus blur, the analysis neural network may apply a defocus deblurring filter to the different parts (for example, such as to different individual pixels) of the input image, to generate the intermediate image. Further, for mitigating the noise, the analysis neural network may apply a denoising filter to the different parts (for example, such as to different regions) of the intermediate image, to generate the output image. There will now be discussed how the analysis neural network is trained.

Optionally, the computer-implemented method further comprises:
training a plurality of neural networks to apply respective ones of the plurality of image processing filters to images, wherein a given neural network corresponding to a given image processing filter is trained using a set of pairs of ground-truth images and corresponding defective images; and
training the analysis neural network using at least a subset of said set, along with weights and biases that are learnt during the training of the given neural network, wherein the analysis neural network is trained using at least subsets of respective sets used for training the plurality of neural networks, along with respective weights and biases that are learnt during the training of the plurality of neural networks.

In this regard, prior to training the analysis neural network, an input is provided to the given neural network in its training phase, wherein said input comprises the set of pairs of the ground-truth images and the corresponding defective images. An output of the given neural network comprises corresponding resulting images that are generated by applying the given neural network to the corresponding defective images.

Herein, the term “resulting image” refers to an image that is generated by applying the given neural network to a corresponding defective image. It will be appreciated that the phrase “applying the given neural network to a given defective image” means that the given neural network is utilised to apply the given image processing filter to at least a part of the given defective image, to generate the resulting image. It will be appreciated that there could be several thousands or hundreds of thousands of different pairs of ground-truth images and defective images that are actually utilised for training the given neural network. The term “ground-truth image” refers to an image that is utilised for evaluating a visual quality of a resulting image that is generated by applying the given neural network to a corresponding defective image, during the training phase of the given neural network. Such an evaluation could, for example, be performed by comparing the ground-truth image and the resulting image, in a pixel-by-pixel manner. Thus, beneficially, the ground-truth images could be utilised as reference images during the training phase of the given neural network. This is because the ground-truth images would be free from any defects, i.e., the ground-truth images would have considerably higher resolution and represent higher visual details (i.e., no motion blur, no defocus blur, no noise, and the like), as compared to the resulting image and the corresponding defective image. Optionally, the given neural network is a convolutional neural network (CNN), a U-net type neural network, an autoencoder, a Residual Neural Network (ResNet), a Vision Transformer (ViT), a neural network having self-attention layers, a generative adversarial network (GAN), a deep unfolding-type (namely, deep unrolling-type) neural network. It will be appreciated that two or more of the aforementioned types of neural networks could also be employed in a parallel or a series combination.

The technical benefit of training the analysis neural network using at least the subset of said set is that the analysis neural network would be efficiently trained for analysing the given image for correctly identifying which parts of the given image are defective, and for identifying which types of image processing filters having a minimum loss need to be applied to such part(s) of the given image, to generate the output image. Moreover, such a process of training the analysis neural network is simple, reliable, computationally-efficient, and time-efficient.

The term “defective image” refers to an image having at least one defect, and is utilised for training the given neural network. It will be appreciated that the defective images could be generated using various techniques, depending on a specific type of image processing filter to be applied by the given neural network. In some implementations, the corresponding defective images of the set are generated artificially, by adding to the ground-truth images a corresponding defect that is to be corrected by the given image processing filter. In other words, the defective images could be generated by introducing artificial defects into otherwise normal images i.e., a visual quality of the otherwise normal images are intentionally-degraded to generate the defective images. In an example, the artificial defects, for example, such as a noise, a motion blur, an occlusions, a distortion, and the like, could be deliberately added to the otherwise normal images, in order to generate the defective images. In other implementations, the corresponding defective images and the ground-truth images of the set could be captured using a low-quality camera and a high-quality camera, respectively. The low-quality camera may be understood to be a camera having lower specifications (for example, such as in terms of a resolution, a dynamic range, a signal-to-noise ratio, a lens quality, image processing capabilities, and the like), as compared to the high-quality camera. The low-quality camera could, for example, be a smartphone camera, a webcam, or similar, whereas the high-quality camera could, for example, be a professional digital single-lens reflex (DSLR) camera, a high-end mirrorless camera, or similar.

It will be appreciated that the weights and the biases in the given neural network are parameters that the given neural network has learnt during its training. The weights and the biases are then utilised to train the analysis neural network. Herein, the term “weight” refers to a parameter that is used to connect different neurons in different layers of the given neural network. A given weight is indicative of a strength and a direction of an influence of a given neuron on another given neuron. Further, the term “bias” refers to a parameter that is added to an output of a given neuron to adjust said output independently of an input of the given neuron, thereby allowing the given neural network to make improved predictions by shifting an activation function of the given neural network. During the training of the given neural network, the weights and the biases are adjusted to minimize an error between the corresponding resulting images and the ground-truth images. Generation and utilisation of the weights and the bias during the training of the given neural network is well-known in the art. When the plurality of neural networks have been trained, the analysis neural network is trained, wherein an input is provided to the analysis neural network in its training phase, and wherein the input comprises at least the subsets of the respective sets used for training the plurality of neural networks along with the respective weights and biases.

Optionally, the training of the given neural network is performed by utilising a loss function, to determine respective losses between the ground-truth images and corresponding resulting images that are generated by applying the given neural network to the corresponding defective images, wherein the training of the plurality of neural networks is performed by utilising a same loss function, and wherein the training of the analysis neural network is performed by utilising the same loss function that was utilised for training the plurality of neural networks.

In this regard, greater the similarity between a visual quality of the corresponding resulting images and a visual quality of the ground-truth images, smaller are the respective losses, better is the training of the given neural network, and higher is the probability of generating highly accurate and defect-free output images in future using the (trained) analysis neural network, and vice versa. It will be appreciated that the respective losses may be computed by employing one or more metrics, for example, such as a Peak Signal to Noise Ratio (PSNR), an L1 pixel-to-pixel (namely, Mean Absolute Error (MAE)), a Structure Similarity Index Measure (SSIM) and its variants (such as a Multi-Scale Structural Similarity Index Measure (MS-SSIM)), a Mean Squared Error (MSE) (namely, an L2-loss), a Huber loss, a Charbonnier loss, a Total Variation (TV) loss, and the like. Training of neural networks using loss functions is well-known in the art.

It will be appreciated that the loss function that is utilised for training the given neural network (and also for training the plurality of neural networks and the analysis neural network) may be generated based on perceptual loss factors, contextual loss factors, and semantic loss factors. Such a loss function would be different from a loss function utilised in the conventional techniques. Moreover, the aforesaid loss factors could have different weights, and a loss function generated based on a combination of the aforesaid loss factors having the different weights, could alternatively be utilised for training the given neural network. The perceptual loss factors may relate to a visual perception of a given resulting image. Instead of solely considering pixel-level differences, the perceptual loss factors aim to measure a similarity in terms of high-level visual features of the given resulting image. As an example, a Learned Perceptual Image Patch Similarity (LPIPS) metric may be used to determine the perceptual loss factors. The perceptual loss factors incorporate feature reconstruction loss factors and style reconstruction loss factors. As another example, Visual Geometry Group (VGG) loss may be used to determine the perceptual loss factors by measuring perceptual differences between two images. The contextual loss factors may take into account a relationship and a coherence between neighbouring pixels in the given resulting image. By incorporating the perceptual loss factors, the contextual loss factors, and the semantic loss factors into a training phase, the given neural network could produce a visually-pleasing and contextually-coherent results when generating the given resulting image. Moreover, the loss function of the given neural network also take into account effects of various image processing filters.

When evaluating a performance of the given neural network and its associated loss function, it can be beneficial to compare the given resulting image and a corresponding ground-truth image at different scales/resolutions. This could be done to assess a visual quality (namely, a visual fidelity) of the given resulting image across various levels of detail/resolutions. For instance, the aforesaid comparison can be made at a highest resolution, which represents an original resolution of the given resulting image. This allows for a detailed evaluation of pixel-level accuracy of the given resulting image. Alternatively or additionally, the aforesaid comparison can be made at a reduced resolution, for example, such as ¼th of the original resolution of the given resulting image. This provides an assessment of an overall perceptual quality and ability of the given neural network to capture and reproduce important visual features in the given resulting image, at coarser levels of detail also. Thus, by evaluating the loss function at different scales/resolutions, more comprehensive understanding of the performance of the given neural network can be known. The loss function, the perceptual factors, the contextual factors, and the semantic loss factors are well-known in the art.

It will also be appreciated that in order to preserve structural details of neighbouring pixels (for example, such as information pertaining to edges, blobs, high-frequency features, and the like) in a given image, and to avoid generation of undesirable artifacts in the given image, a gradient loss function (L) could be beneficially employed in a pixel-by-pixel manner. The gradient loss function (L) could, for example, be represented as follows:

$$L = ‖ ∇ Y - ∇ {Y}^{′} ‖ + ‖ {∇}^{′} Y - {∇}^{′} {Y}^{′} ‖$$

wherein ∇ represents a horizontal gradient operation, and ∇′ represent a vertical gradient operation. The gradient loss function (L) measures a discrepancy between gradients of two versions of the (same) given image in both a horizontal direction and a vertical direction. Various gradient loss functions may also be employed apart from that mentioned above. As an example, a gradient loss function may comprise masks that selectively exclude or include certain pixels, for example, such as only defective pixels of the given image would be considered while determining said gradient loss function. By using masks to control inclusion or exclusion of the certain pixels, the gradient loss function can be employed to focus on specific regions or features of interest in the given image. This flexibility allows for more fine-grained control over a preservation of the structural details in the given image.

The technical benefit of utilising the same loss function that was utilised for training the plurality of neural networks, for the training of the analysis neural network, is that the same loss function may facilitate the analysis neural network to analyse the given image, and compare and determine which image processing filter from amongst the plurality of image processing filters could be applied to the given part of the given image so as to have the minimal loss. As a result, when the (trained) analysis neural network is utilized, the generated output image would be highly accurate and realistic (i.e., without any defects or with negligible defects that would be imperceptible/unnoticeable to the at least one user), in a computationally-efficient and a time-efficient manner. It will be appreciated that alternatively, there could also be different loss functions corresponding to different neural networks, wherein the training of the analysis neural network is optionally performed by utilising the different loss functions that were utilised for training the different neural networks.

In an embodiment, a first output of the analysis neural network comprises a pixel map that comprises, for a given pixel of the input image, a code that indicates a first image processing filter that is to be applied to the given pixel. The term “pixel map” refers to a data structure comprising information pertaining to respective codes for different individual pixels of the input image, wherein the respective codes indicate the respective first image processing filters that are to be applied to the different individual pixels of the input image. The data structure could, for example, be a look-up table. It will be appreciated that when the different parts of the input image are the different individual pixels of the input image, the analysis neural network analyses the input image in a pixel-by-pixel manner, and selects the respective first image processing filters for the different individual pixels of the input image. It is to be noted that the respective first image processing filters are not selected for an entirety of the different individual pixels of the input image, but are selected for only those pixels of the input image that correspond to the at least one defect. This is because image processing filters need not be applied to non-defective (namely, already-accurate) pixels of the input image. Thus, the pixel map would be generated by the analysis neural network accordingly, for only those pixels of the input image that correspond to the at least one defect, based on a type of the at least one defect. It will be appreciated that pixels of the input image having a same type of the at least one defect may have a same code, as a same image processing filter may be applied to said pixels of the input image. As an example, a code that indicates a motion deblurring filter that is to be applied to a given pixel, is different from a code that indicates a super-resolution filter that is to be applied to another given pixel. The technical benefit of generating the pixel map is that the analysis neural network can conveniently and accurately utilize the pixel map for applying the respective first image processing filters to the different individual pixels of the input image, to generate the output image (or optionally, the intermediate image). In this manner, the output image (or optionally, the intermediate image) is generated in real time or near-real time.

Optionally, a second output of the analysis neural network comprises a pixel map that comprises, for a given pixel of the intermediate image, a code that indicates a second image processing filter that is to be applied to the given pixel.

Optionally, a given code is one of: a numeric code, an alphabetic code, an alphanumeric code. The given code may be represented using 4 bits, 6 bits, 8 bits, or similar.

Optionally, the computer-implemented method further comprises:
obtaining information indicative of a gaze direction;
determining a given region of the input image, based on the gaze direction; and
selecting a first image processing filter to be applied to the given region, based on at least one of: (i) a code that is same for at least a predefined percent of pixels in the given region, (ii) weightages of respective codes of the pixels in the given region.

The gaze direction could be a gaze direction of a user. Optionally, in this regard, the information indicative of the gaze direction of the user can be obtained from a client device of the user. The client device could be implemented, for example, as a head-mounted display (HMD) device.

Optionally, the client device comprises a gaze tracker and a processor configured to determine the gaze direction of the user by utilising the gaze-tracker. In general, the client device can comprise gaze tracker means, that can be implemented in various ways such as provided below with use of the gaze-tracker and the associated processor. The term “gaze direction” refers to a direction in which a given eye of the user is gazing. The gaze direction may be represented by a gaze vector. Furthermore, the term “gaze tracker” refers to specialized equipment for detecting and/or following a gaze of the user's eyes. The gaze tracker could be implemented as at least one of:
(i) contact lenses with sensors (for example, such as a microelectromechanical systems (MEMS) accelerometer and a gyroscope employed to detect a movement and an orientation of a given eye, and/or electrodes employed to measure electrooculographic (EOG) signals generated by the movement of the given eye),
(ii) at least one infrared (IR) light source and at least one IR camera, wherein the at least one IR light source is employed to emit IR light towards the given eye, while the at least one IR camera is employed to determine a position of a pupil of the given eye with respect to at least one glint (formed due to a reflection of the IR light off an ocular surface of the given eye),
(iii) at least one camera, employed to determine a position of the pupil of the given eye with respect to corners of the given eye, and optionally, to determine a size and/or a shape of the pupil of the given eye,
(iv) a plurality of light field sensors employed to capture a wavefront of light reflected off the ocular surface of the given eye, wherein the wavefront is indicative of a geometry of a part of the ocular surface that reflected the light,
(v) a plurality of light sensors and optionally, a plurality of light emitters, wherein the plurality of light sensors are employed to sense an intensity of light that is incident upon these light sensors upon being reflected off the ocular surface of the given eye, and to determine a direction from which the light is incident upon these light sensors.

Such gaze trackers are well-known in the art. The term “head-mounted display” device refers to specialized equipment that is configured to present an XR environment to the user when said HMD, in operation, is worn by the user on his/her head. The HMD is implemented, for example, as an XR headset, a pair of XR glasses, and the like, that is operable to display a visual scene of the XR environment to the user. The term “extended-reality” encompasses virtual reality (VR), augmented reality (AR), mixed reality (MR), and the like.

Optionally, when determining the given region of the input image, the at least one processor is configured to map the gaze direction onto the input image. The given region of the input image is at least one of: the gaze region, the peripheral region surrounding the gaze region. The given region of the input image may comprise a plurality of pixels. The term “gaze region” refers to a region of the input image onto which the gaze direction is mapped. The gaze region may, for example, be a central region of the input image, a top-left region of the input image, a bottom-right region of the input image, or similar. The term “peripheral region” refers to another region in the input image that surrounds the gaze region. The another region may, for example, remain after excluding the gaze region from the input image. Optionally, an angular width of the peripheral region lies in a range of 12.5-50 degrees from a gaze position to 45-110 degrees from the gaze position, while an angular extent of the gaze region lies in a range of 0 degree from the gaze position to 2-50 degrees from the gaze position.

It will be appreciated that when at least the predefined percent of the pixels in the given region have a same code, the analysis neural network would select the first image processing filter as indicated by the same code. For example, when 50 percent or more pixels in the given region have a same code, the analysis neural network may select the first image processing filter as indicated by the same code. Upon said selection, the first image processing filter would be applied to the given region. Alternatively or additionally, optionally, a selection of the first image processing filter for the given region is done by using weightages of the respective codes associated with the pixels in the given region. Depending on a type of the given region, some codes may have higher weightage as compared to other codes. Thus, for the given region, an image processing filter indicated by a code that has a higher weightage as compared to another code, would be applied to the given region. As an example, for the gaze region of the input image, a motion deblurring filter (and its associated code) may have a higher weightage as compared to a denoising filter (and its associated code). This is because a motion blur is likely a more significant defect in the gaze region, as it can severely degrade important visual details in the gaze region. Thus, prioritising the motion deblurring filter (because of the higher weightage) ensures that the visual details in the gaze region would become sharp and in-focus, which may be more critical than addressing/correcting a noise in the gaze region (via the denoising filter). On the other hand, for the peripheral region of the input image, the denoising filter (and its associated code) may have a higher weightage as compared to a motion deblurring filter (and its associated code). This is because the noise is likely a more significant defect in the peripheral region, as the noise is more perceivable (i.e., noticeable) to the user, in the peripheral region as compared to the gaze region. Thus, prioritising the denoising filter (because of the higher weightage) ensures that the peripheral region would become noise-free, which may be more critical than addressing/correcting the motion blur in the gaze region (via the motion deblurring filter). Advantageously, when the first image processing filter is selected in the aforesaid manner, the gaze region and the peripheral region of the input image could be corrected for any defect present thereat, to generate a foveated output image that has an overall high image-quality, and is defect-free. Presenting such output images to the user can improve a viewing experience of the user, for example, in terms of realism and immersiveness.

In an alternative embodiment, a first output of the analysis neural network comprises a region map that comprises, for a given region of the input image, a code that indicates a first image processing filter that is to be applied to the given region. The term “region map” refers to a data structure comprising information pertaining to respective codes for different regions of the input image, wherein the respective codes indicate respective first image processing filters that are to be applied to the different regions of the input image. It will be appreciated that when the different parts of the input image are the different regions of the input image, the analysis neural network analyses the input image in a region-by-region manner, and selects the respective first image processing filters for the different regions of the input image. The given region of the input image may comprise a plurality of pixels. It is to be noted that the respective first image processing filters are not selected for each and every region of the input image, but are selected for only those regions of the input image that correspond to the at least one defect. This is because image processing filters need not be applied to non-defective (namely, already-accurate) regions of the input image. Thus, the region map would be generated by the analysis neural network accordingly, for only those regions of the input image that correspond to the at least one defect, based on a type of the at least one defect. It will be appreciated that regions of the input image having a same type of the at least one defect may have a same code, as a same image processing filter may be applied to said regions of the input image. As an example, a code that indicates a defocus deblurring filter that is to be applied to a given region of the input image, is different from a code that indicates an inpainting filter that is to be applied to another given region of the input image. The technical benefit of generating the region map is that the analysis neural network can conveniently and accurately utilise the region map for applying the respective first image processing filters to the different regions of the input image, to generate the output image (or optionally, the intermediate image). In this manner, the output image (or optionally, the intermediate image) is generated in real time or near-real time. Optionally, a second output of the analysis neural network comprises a region map that comprises, for a given region of the intermediate image, a code that indicates a second image processing filter that is to be applied to the given region.

Optionally, the computer-implemented method further comprises providing information indicative of a gaze direction as an input to the analysis neural network, wherein the given region of the input image is determined based on said gaze direction. In this regard, instead of determining the given region of the input image by the at least one processor itself, the information indicative of the gaze direction is provided to the analysis neural network, for determining the given region of the input image, in a similar manner as discussed earlier. The technical benefit of this is that the given region of the input image is highly accurately determined, with minimal computational resources and time. Moreover, by providing the information indicative of the gaze direction as the input, the analysis neural network could adjust its processing dynamically to prioritise aspects of the input image that are perceptually important to a human vision. For example, the analysis neural network can enhance a noise reduction in the given part of the input image, while minimising a loss of sharpness in said given part, or the analysis neural network can emphasise on certain focussing cues, for example, making edges sharper and more contrasted in the given part, which are crucial for improving visual perception of the output image. Additionally, a colour accuracy can also be enhanced in the given part when the information indicative of the gaze direction is known, ensuring that the output image better matches a human perception of colours. In one case, the gaze direction could be a gaze direction of a single user. In another case, the gaze direction could be an average gaze direction for multiple users. In yet another case, the gaze direction could be a default gaze direction (for example, towards a central region of the input image). Information pertaining to the gaze direction has been already discussed earlier in detail. Optionally, upon determining the given region of the input image, the analysis neural network is utilised to select a first image processing filter to be applied to the given region, based on at least one of: (i) a code that is same for at least a predefined percent of pixels in the given region, (ii) weightages of respective codes of the pixels in the given region, in a same manner as discussed earlier. Advantageously, when the first image processing filter is selected in the aforesaid manner, the gaze region and the peripheral region of the input image could be corrected for any defect present thereat, to generate a foveated output image that has an overall high image-quality, and is defect-free. Presenting such output images to the user can improve a viewing experience of the user, for example, in terms of realism and immersiveness.

It will be appreciated that the region map may, particularly, be beneficial for applying a given image processing filter to the peripheral region, whereas the pixel map may, particularly, be beneficial for applying the given image processing filter (or may be another given image processing filter) to the gaze region. This may be because an accuracy of applying the given image processing filter in a pixel-by-pixel manner is higher, as compared to applying the given image processing filter on an entirety of a given region at once. Moreover, applying the given image processing filter in the pixel-by-pixel manner requires considerable processing time and processing resources of the at least one processor, as compared to applying the given image processing filter on the entirety of the given region at once. However, since a field of view of the gaze region (namely, a region of interest) is significantly smaller as compared to the peripheral region, an overall processing time and a consumption of the processing resources of the at least one processor are minimized. It will be appreciated that it may be pre-known to the analysis neural network that certain image processing filter(s) is/are more beneficial when applied to the peripheral region of the input image (for example, a noise reduction or other similar enhancements can significantly enhance the peripheral region), as compared to the gaze region of the input image. Similarly, applying certain image processing filters to the gaze region may ensure that visual enhancements are applied precisely to areas where human attention is directed, potentially enhancing clarity, sharpness, or other perceptual qualities important for improving a visual experience of the user.

In yet alternative embodiment, a first output of the analysis neural network comprises an image segment map, the input image being divided into a plurality of image segments, wherein the image segment map comprises, for a given image segment, a code that indicates a first image processing filter that is to be applied to the given image segment. The term “image segment map” refers to a data structure comprising information pertaining to respective codes for different image segments of the input image, wherein the respective codes indicate respective first image processing filters that are to be applied to the different image segments of the input image. It will be appreciated that when the different parts of the input image are the different image segments of the input image, the analysis neural network analyses the input image in an image segment-by-image segment manner, and selects the respective first image processing filters for the different image segments of the input image. The term “image segment” of a given image refers to a portion (namely, a segment) of the given image. A given image segment of the given image may or may not have a defined shape and/or size. The given image segment of the given image may comprise a plurality of pixels.

It is to be noted that the respective first image processing filters are not selected for each and every image segment of the input image, but are selected for only those image segments of the input image that correspond to the at least one defect. This is because image processing filters need not be applied to non-defective (namely, already-accurate) image segment of the input image. Thus, the image segment map would be generated by the analysis neural network accordingly, for only those image segments of the input image that correspond to the at least one defect, based on a type of the at least one defect. It will be appreciated that image segments of the input image having a same type of the at least one defect may have a same code, as a same image processing filter may be applied to said image segments of the input image. As an example, a code that indicates a defocus deblurring filter that is to be applied to a given image segment of the input image, is different from a code that indicates an inpainting filter that is to be applied to another given image segment of the input image. The technical benefit of generating the image segment map is that the analysis neural network can conveniently and accurately utilise the image segment map for applying the respective first image processing filters to the different image segments of the input image, to generate the output image (or optionally, the intermediate image). In this manner, the output image (or optionally, the intermediate image) is generated in real time or near-real time. Optionally, a second output of the analysis neural network comprises an image segment map, the intermediate image being divided into a plurality of image segments, wherein the image segment map comprises, for a given image segment of the intermediate image, a code that indicates a second image processing filter that is to be applied to the given image segment.

It will be appreciated that the input image is optionally divided into the plurality of image segment by the analysis neural network itself. The aforesaid division of the input image could be performed, for example, by using at least one of: a colour analysis, a contrast analysis, a semantic analysis, an edge detection, a Fourier analysis, a blurriness analysis, and an activity analysis. In this regard, in the colour analysis, pixels of a given image having a same colour may be identified and grouped together to form a given segment. In an example, in a given image, three image segments may correspond to a blue colour sky, a green colour tree, and a brown colour ground, respectively. Further, in the contrast analysis, the plurality of image segments may be determined by differentiating high-contrast areas from low-contrast areas in the given image. For example, bright and dark regions are identified in the given image to form different image segments. In the semantic analysis, contextual information in the given image may be used to segment the given image into meaningful parts, for example, such as separating the sky from buildings in a cityscape represented in the given image. Moreover, the semantic analysis may utilise deep learning models to identify and segment different objects (such as people, cars, trees, or the like) represented in the given image. In the edge detection, the analysis neural network may divide the given image by detecting edges of different objects represented in the given image, and also by identifying areas in the given image where there is a rapid change in a colour intensity. In the Fourier analysis, the given image may be transformed into a frequency domain using a Fourier transform technique, and different frequency components in the given image are analysed to identify repetitive patterns or textures, for determining different image segments. In the activity analysis, the plurality of image segments are determined, based on moving objects or areas of activity represented in the given image. The technical benefit of using any of the aforesaid analyses is that the input image can be accurately divided into the plurality of image segment such that the respective first image processing filters can be applied to the different image segments of the input image in a precise manner. All the aforementioned analyses for performing a division of the given image are well-known in the art. It will be appreciated that perceptual loss factors and/or the context loss factors (described earlier) could also be calculated using the aforementioned analyses.

The present disclosure also relates to the computer-implemented method of the second aspect as described above. Various embodiments and variants disclosed above, with respect to the aforementioned computer-implemented method of the first aspect, apply mutatis mutandis to the computer-implemented method of the second aspect.

Optionally, in the computer-implemented method, the training of the given neural network is performed by utilising a loss function, to determine respective losses between the ground-truth images and corresponding resulting images that are generated by applying the given neural network to the corresponding defective images, wherein the training of the plurality of neural networks is performed by utilising a same loss function, and wherein the training of the analysis neural network is performed by utilising the same loss function that was utilised for training the plurality of neural networks.

Optionally, in the computer-implemented method, the corresponding defective images of the set are generated artificially, by adding to the ground-truth images a corresponding defect that is to be corrected by the given image processing filter.

Optionally, in the computer-implemented method, the analysis neural network is a convolutional neural network (CNN).

The present disclosure also relates to the system as described above. Various embodiments and variants disclosed above, with respect to the aforementioned computer-implemented method of the first aspect, apply mutatis mutandis to the system.

Optionally, the respective first image processing filters are applied to the different parts of the input image, to generate an intermediate image, wherein the at least one processor is further configured to:
utilise the analysis neural network to select a second image processing filter from amongst the plurality of image processing filters that is to be applied to a given part of the intermediate image, wherein the analysis neural network is trained to select an image processing filter having a minimum loss for the given part of the intermediate image as the second image processing filter, wherein respective second image processing filters are selected for different parts of the intermediate image; and
apply the respective second image processing filters to the different parts of the intermediate image, to generate an output image.

Optionally, in the system, a first output of the analysis neural network comprises a pixel map that comprises, for a given pixel of the input image, a code that indicates a first image processing filter that is to be applied to the given pixel.

Optionally, the at least one processor is further configured to:
obtain information indicative of a gaze direction;
determine a given region of the input image, based on the gaze direction; and
select a first image processing filter to be applied to the given region, based on at least one of: (i) a code that is same for at least a predefined percent of pixels in the given region, (ii) weightages of respective codes of the pixels in the given region.

Optionally, in the system, a first output of the analysis neural network comprises a region map that comprises, for a given region of the input image, a code that indicates a first image processing filter that is to be applied to the given region.

Optionally, the at least one processor is further configured to provide information indicative of a gaze direction as an input to the analysis neural network, wherein the given region of the input image is determined based on said gaze direction.

Optionally, in the system, a first output of the analysis neural network comprises an image segment map, the input image being divided into a plurality of image segments, wherein the image segment map comprises, for a given image segment, a code that indicates a first image processing filter that is to be applied to the given image segment.

Optionally, the at least one processor is further configured to:
train a plurality of neural networks to apply respective ones of the plurality of image processing filters to images, wherein a given neural network corresponding to a given image processing filter is trained using a set of pairs of ground-truth images and corresponding defective images; and
train the analysis neural network using at least a subset of said set, along with weights and biases that are learnt during the training of the given neural network, wherein the analysis neural network is trained using at least subsets of respective sets used for training the plurality of neural networks, along with respective weights and biases that are learnt during the training of the plurality of neural networks.

Optionally, in the system, the training of the given neural network is performed by utilising a loss function, to determine respective losses between the ground-truth images and corresponding resulting images that are generated by applying the given neural network to the corresponding defective images, wherein the training of the plurality of neural networks is performed by utilising a same loss function, and wherein the training of the analysis neural network is performed by utilising the same loss function that was utilised for training the plurality of neural networks.

### DETAILED DESCRIPTION OF THE DRAWINGS

Referring to FIG. 1, illustrated are steps of a method incorporating effective image processing using a neural network, in accordance with a first aspect of the present disclosure. With reference to FIG. 1, at step 102, an analysis neural network is utilised to select a first image processing filter from amongst a plurality of image processing filters that is to be applied to a given part of an input image, wherein the analysis neural network is trained to select an image processing filter having a minimum loss for the given part of the input image as the first image processing filter, wherein respective first image processing filters are selected for different parts of the input image. At step 104, the respective first image processing filters are applied to the different parts of the input image.

The aforementioned steps are only illustrative and other alternatives can also be provided where one or more steps are added, one or more steps are removed, or one or more steps are provided in a different sequence without departing from the scope of the claims.

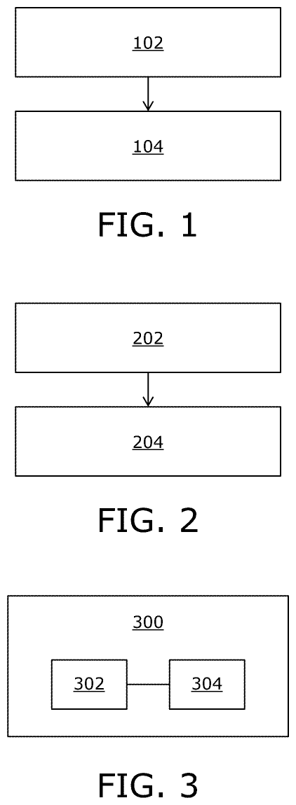

Referring to FIG. 2, illustrated are steps of a method incorporating effective image processing using a neural network, in accordance with a second aspect of the present disclosure. With reference to FIG. 2, at step 202, a plurality of neural networks are trained to apply respective ones of a plurality of image processing filters to images, wherein a given neural network corresponding to a given image processing filter is trained using a set of pairs of ground-truth images and corresponding defective images. At step 204, an analysis neural network is trained using at least a subset of said set, along with weights and biases that are learnt during the training of the given neural network, wherein the analysis neural network is trained using at least subsets of respective sets used for training the plurality of neural networks, along with respective weights and biases that are learnt during the training of the plurality of neural networks, further wherein the analysis neural network is trained to select an image processing filter from amongst the plurality of image processing filters that has a minimum loss for a given part of an input image, for applying to the given part of the input image.

The aforementioned steps are only illustrative and other alternatives can also be provided where one or more steps are added, one or more steps are removed, or one or more steps are provided in a different sequence without departing from the scope of the claims.

Referring to FIG. 3, illustrated is a block diagram of an architecture of a system 300 incorporating effective image processing using a neural network, in accordance with a third aspect of the present disclosure. With reference to FIG. 3, the system 300 comprises a data storage 302 for storing an analysis neural network, and at least one processor (for example, depicted as a processor 304). The processor 304 is communicably coupled to the data storage 302. The processor 304 is configured to perform various operations, as described earlier with respect to the aforementioned first aspect.

It may be understood by a person skilled in the art that FIG. 3 includes a simplified architecture of the system 300, for sake of clarity, which should not unduly limit the scope of the claims herein. It is to be understood that the specific implementation of the system 300 is provided as an example and is not to be construed as limiting it to specific numbers or types of data storages and processors. The person skilled in the art will recognize many variations, alternatives, and modifications of embodiments of the present disclosure.

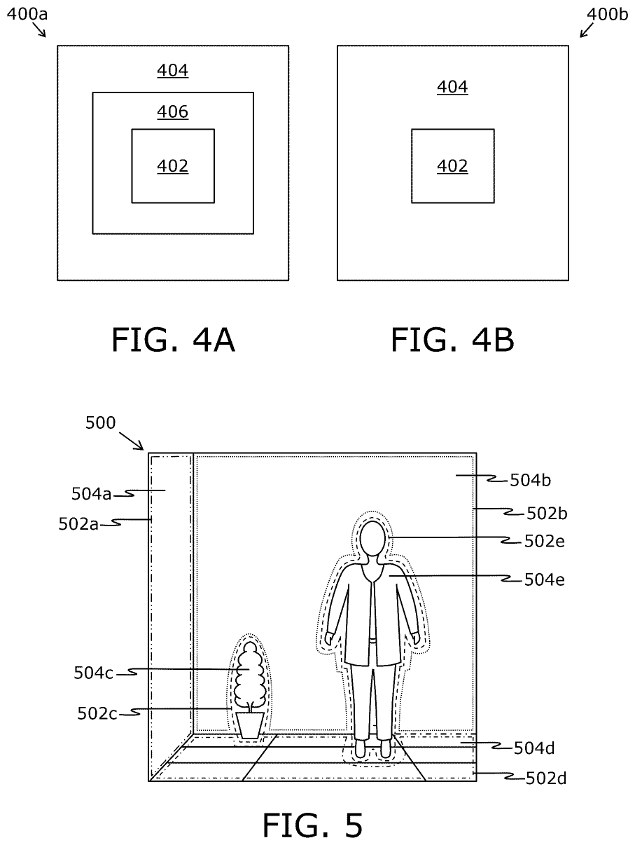

Referring to FIGS. 4A and 4B, illustrated are different regions of an input image 400, in accordance with an embodiment of the present disclosure. With reference to FIGS. 4A and 4B, the input image 400 comprises a gaze region 402 and a peripheral region 404, wherein the peripheral region 404 surrounds the gaze region 402. The gaze region 402 and the peripheral region 404 are determined (by at least one processor), based on a gaze direction of a user (for example, at a centre of a field-of-view of the user). With reference to FIG. 4B, the input image 400 is shown to further comprise an intermediate region 406, wherein the intermediate region 406 lies between the gaze region 402 and the peripheral region 404.

FIGS. 4A and 4B are merely examples, which should not unduly limit the scope of the claims herein. The person skilled in the art will recognize many variations, alternatives, and modifications of embodiments of the present disclosure. For sake of simplicity, the different regions are only shown for the input image 400. Similarly, there could also be an intermediate image which comprise a gaze region, a peripheral region, and an intermediate region, wherein said intermediate image is generated upon applying respective first image processing filters to different parts (namely, regions) of the input image 400.

Referring to FIG. 5, illustrated is an input image 500 being divided into a plurality of image segments 502a (depicted using a dash double-dot line), 502b (depicted using a dotted line), 502c (depicted using a dashed line), 502d (depicted using a dash dot line), and 502e (depicted using a dashed line), in accordance with an embodiment of the present disclosure. With reference to FIG. 5, the plurality of image segments 502a, 502b, 502c, 502d, and 502e correspond to a plurality of objects 504a, 504b, 504c, 504d, and 504e, depicted as a first wall, a second wall, an indoor plant, a tiled floor, and a human, respectively, represented in the input image 500. As shown, different image segments have different shapes and sizes.

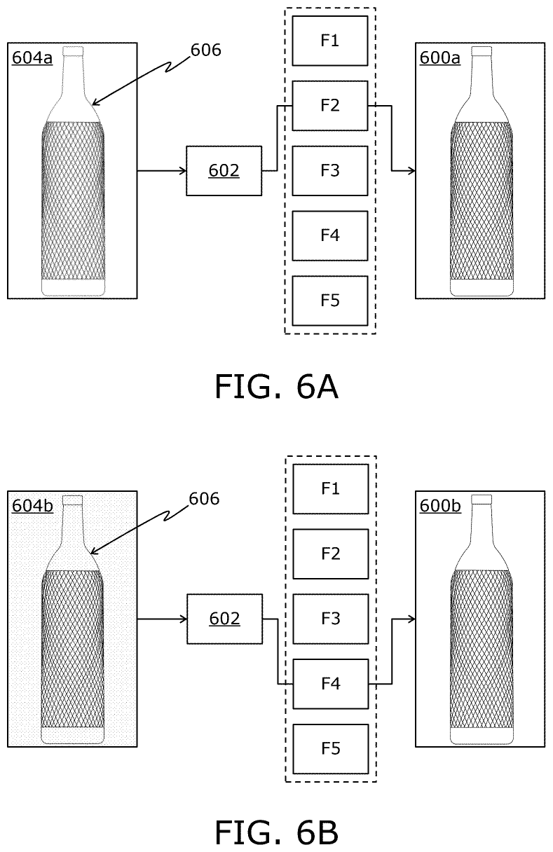

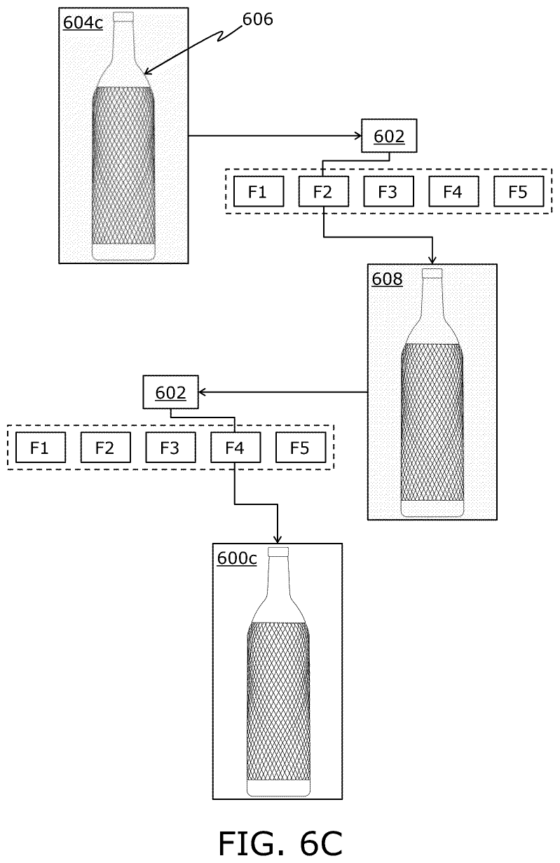

Referring to FIGS. 6A, 6B, and 6C, illustrated are different exemplary scenarios of generating different output images 600a, 600b, and 600c by utilising an analysis neural network 602, respectively, in accordance with an embodiment of the present disclosure. With reference to FIGS. 6A-6C, F1, F2, F3, F4, and F5 refer to different image processing filters, wherein the image processing filter F1 is an image sharpening filter, the image processing filter F2 is a defocus deblurring filter, the image processing filter F3 is a motion deblurring filter, the image processing filter F4 is an image denoising filter, and the image processing filter F5 is an image super-resolution filter, for sake of simplicity and better understanding.

With reference to FIG. 6A, there is shown a first exemplary scenario of generating the output image 600a. An input image 604a is provided as an input to the analysis neural network 602, wherein the analysis neural network 602 is utilised to select a first image processing filter from amongst a plurality of image processing filters (for example, depicted as the image processing filters F1, F2, F3, F4, and F5) that is to be applied to a given part of the input image 604a, and wherein the analysis neural network is trained to select an image processing filter from amongst the image processing filters F1-F5 that has a minimum loss for the given part of the input image 604a, for applying to the given part of the input image 604a. As shown, the input image 604a represents an object 606 (for example, depicted as a bottle), wherein said object 606 appears to be blurred (namely, out-of-focus) due to a defocus blur. Thus, upon analysing the input image 604a, the analysis neural network 602 selects the image processing filter F2 (i.e., the defocus deblurring filter) as the first image processing filter to be applied to an entirety of the input image 604a, to generate the output image 600a. As shown, the object 606 in the output image 600a appears to be in-focus (namely, clearly visible). Upon said generation, the output image 600a may be displayed to a user. For illustration purposes and better understanding, the defocus blur is shown to be present in the entirety of the input image 604a. Said defocus blur could alternatively be present in only some parts of the input image 604a; in such a case, the image processing filter F2 could be applied to only those parts of the input image 604a accordingly.

With reference to FIG. 6B, there is shown a second exemplary scenario of generating the output image 600b. An input image 604b is provided as an input to the analysis neural network 602, wherein the analysis neural network 602 is utilised to select a first image processing filter from amongst a plurality of image processing filters (for example, depicted as the image processing filters F1, F2, F3, F4, and F5) that is to be applied to a given part of the input image 604b, and wherein the analysis neural network is trained to select an image processing filter from amongst the image processing filters F1-F5 that has a minimum loss for the given part of the input image 604b, for applying to the given part of the input image 604b. As shown, the input image 604b represents an object 606 (for example, depicted as a bottle), wherein said object 606 appears to be unclear due to a presence of a noise. Thus, upon analysing the input image 604b, the analysis neural network 602 selects the image processing filter F4 (i.e., the image denoising filter) as the first image processing filter to be applied to an entirety of the input image 604b, to generate the output image 600b. As shown, the object 606 in the output image 600b appears to be clearly visible (namely, without any noise). Upon said generation, the output image 600b may be displayed to a user. For illustration purposes and better understanding only, the noise is shown to be present in the entirety of the input image 604b. Said noise could alternatively be present in only some parts of the input image 604b; in such a case, the image processing filter F4 could be applied to only those parts of the input image 604b accordingly.

With reference to FIG. 6C, there is shown a third exemplary scenario of generating the output image 600c. An input image 604c is provided as an input to the analysis neural network 602, wherein the analysis neural network 602 is utilised to select a first image processing filter from amongst a plurality of image processing filters (for example, depicted as the image processing filters F1, F2, F3, F4, and F5) that is to be applied to a given part of the input image 604c, and wherein the analysis neural network is trained to select an image processing filter from amongst the image processing filters F1-F5 that has a minimum loss for the given part of the input image 604c, for applying to the given part of the input image 604c. As shown, the input image 604c represents an object 606 (for example, depicted as a bottle), wherein said object 606 appears to be both blurred and unclear, due to a presence of a defocus blur and a noise. Thus, upon analysing the input image 604c, the analysis neural network 602 selects the image processing filter F2 (i.e., the defocus deblurring filter) as the first image processing filter to be applied to an entirety of the input image 604c, to generate an intermediate image 608. As a result, the object 606 appears to be in-focus in the intermediate image 606, but is still unclear due to the presence of the noise. Therefore, the intermediate image 608 is now provided as an input to the (same) analysis neural network 602, and upon analysing the intermediate image 608 (in a similar manner as for the input image 604c, as discussed hereinabove), the analysis neural network 602 selects the image processing filter F4 (i.e., the image denoising filter) as a second image processing filter to be applied to an entirety of the intermediate image 608, to generate an output image 600c. As shown, the object 606 now appears to be in-focus and is also clearly visible (namely, without any noise) in the output image 600c. It is to be understood that the intermediate image 608 is not displayed to a user, and only the output image 600c may be displayed to the user. For illustration purposes and better understanding only, the defocus blur and the noise are shown to be present in the entirety of the input image 604c. Alternatively, the defocus blur and the noise could be present in only some parts of the input image 604c.

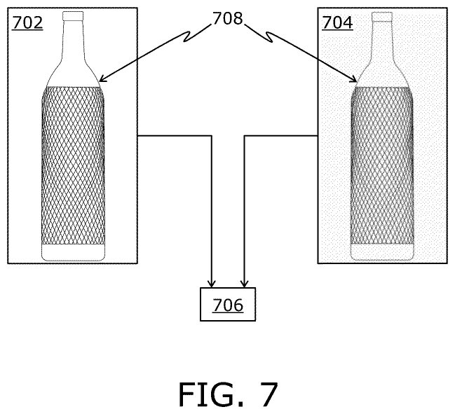

Referring to FIG. 7, illustrated is an exemplary pair of a ground-truth image 702 and a defective image 704 that is utilised for training a given neural network 706, in accordance with an embodiment of the present disclosure. With reference to FIG. 7, the ground-truth image 702 and the defective image 704 represent an object 708 (for example, depicted as a bottle). In an example implementation, the ground-truth image 702 may be captured using a high-quality camera, whereas the defective image 704 may be captured using a relatively low-quality camera. Therefore, the ground-truth image 702 has a considerably higher resolution and represent high-quality visual details of the object 708, as compared to the defective image 704. As an example, as shown, the ground-truth image 702 is in-focus and clear, whereas the defective image 704 has a defocus blur and is unclear. Further, the training of the given neural network 706 is performed by utilising a loss function, to determine a loss between the ground-truth image 702 and a resulting image (not shown) that is generated by applying the given neural network 706 to the defective image 704, wherein a training of an analysis neural network (for example, such as the analysis neural network 602 as depicted in FIGS. 6A, 6B, and 6C) is performed by utilising a same loss function. Hereinabove, the phrase “applying the given neural network to the defective image” means that the given neural network 706 is utilised to apply a given image processing filter (for example, such as a defocus deblurring filter) to at least a part of the defective image 704, to generate the resulting image. It will be appreciated that there could be several thousands or hundreds of thousands of different pairs of ground-truth images and defective images that are actually utilised for training the given neural network 706. For illustration purposes, only one pair of the ground-truth image 702 and the defective image 704 is shown in FIG. 7.

FIGS. 5, 6A, 6B, 6C, and 7 are merely examples, which should not unduly limit the scope of the claims herein. The person skilled in the art will recognize many variations, alternatives, and modifications of embodiments of the present disclosure.

1. A computer-implemented method comprising:
utilising an analysis neural network to select a first image processing filter from amongst a plurality of image processing filters that is to be applied to a given part of an input image, wherein the analysis neural network is trained to select an image processing filter having a minimum loss for the given part of the input image as the first image processing filter, wherein respective first image processing filters are selected for different parts of the input image; and
applying the respective first image processing filters to the different parts of the input image.

2. The computer-implemented method of claim 1, wherein the respective first image processing filters are applied to the different parts of the input image, to generate an intermediate image, the method further comprising:
utilising the analysis neural network to select a second image processing filter from amongst the plurality of image processing filters that is to be applied to a given part of the intermediate image, wherein the analysis neural network is trained to select an image processing filter having a minimum loss for the given part of the intermediate image as the second image processing filter, wherein respective second image processing filters are selected for different parts of the intermediate image; and
applying the respective second image processing filters to the different parts of the intermediate image, to generate an output image.

3. The computer-implemented method of claim 1, wherein a first output of the analysis neural network comprises a pixel map that comprises, for a given pixel of the input image, a code that indicates a first image processing filter that is to be applied to the given pixel.

4. The computer-implemented method of claim 3, further comprising:
obtaining information indicative of a gaze direction;
determining a given region of the input image, based on the gaze direction; and
selecting a first image processing filter to be applied to the given region, based on at least one of: (i) a code that is same for at least a predefined percent of pixels in the given region, (ii) weightages of respective codes of the pixels in the given region.

5. The computer-implemented method of claim 1, wherein a first output of the analysis neural network comprises a region map that comprises, for a given region of the input image, a code that indicates a first image processing filter that is to be applied to the given region.

6. The computer-implemented method of claim 5, further comprising providing information indicative of a gaze direction as an input to the analysis neural network, wherein the given region of the input image is determined based on said gaze direction.

7. The computer-implemented method of claim 1, wherein a first output of the analysis neural network comprises an image segment map, the input image being divided into a plurality of image segments, wherein the image segment map comprises, for a given image segment, a code that indicates a first image processing filter that is to be applied to the given image segment.

8. The computer-implemented method of claim 1, further comprising:
training a plurality of neural networks to apply respective ones of the plurality of image processing filters to images, wherein a given neural network corresponding to a given image processing filter is trained using a set of pairs of ground-truth images and corresponding defective images; and
training the analysis neural network using at least a subset of said set, along with weights and biases that are learnt during the training of the given neural network, wherein the analysis neural network is trained using at least subsets of respective sets used for training the plurality of neural networks, along with respective weights and biases that are learnt during the training of the plurality of neural networks.

9. The computer-implemented method of claim 8, wherein the training of the given neural network is performed by utilising a loss function, to determine respective losses between the ground-truth images and corresponding resulting images that are generated by applying the given neural network to the corresponding defective images, wherein the training of the plurality of neural networks is performed by utilising a same loss function, and wherein the training of the analysis neural network is performed by utilising the same loss function that was utilised for training the plurality of neural networks.

10. A computer-implemented method comprising:
training a plurality of neural networks to apply respective ones of a plurality of image processing filters to images, wherein a given neural network corresponding to a given image processing filter is trained using a set of pairs of ground-truth images and corresponding defective images; and
training an analysis neural network using at least a subset of said set, along with weights and biases that are learnt during the training of the given neural network, wherein the analysis neural network is trained using at least subsets of respective sets used for training the plurality of neural networks, along with respective weights and biases that are learnt during the training of the plurality of neural networks, further wherein the analysis neural network is trained to select an image processing filter from amongst the plurality of image processing filters that has a minimum loss for a given part of an input image, for applying to the given part of the input image.

11. The computer-implemented method of claim 10, wherein the training of the given neural network is performed by utilising a loss function, to determine respective losses between the ground-truth images and corresponding resulting images that are generated by applying the given neural network to the corresponding defective images, wherein the training of the plurality of neural networks is performed by utilising a same loss function, and wherein the training of the analysis neural network is performed by utilising the same loss function that was utilised for training the plurality of neural networks.

12. A system comprising:
a data storage for storing an analysis neural network; and
at least one processor configured to:
utilise the analysis neural network to select a first image processing filter from amongst a plurality of image processing filters that is to be applied to a given part of an input image, wherein the analysis neural network is trained to select an image processing filter having a minimum loss for the given part of the input image as the first image processing filter, wherein respective first image processing filters are selected for different parts of the input image; and
apply the respective first image processing filters to the different parts of the input image.

13. The system of claim 12, wherein the respective first image processing filters are applied to the different parts of the input image, to generate an intermediate image, wherein the at least one processor is further configured to:
utilise the analysis neural network to select a second image processing filter from amongst the plurality of image processing filters that is to be applied to a given part of the intermediate image, wherein the analysis neural network is trained to select an image processing filter having a minimum loss for the given part of the intermediate image as the second image processing filter, wherein respective second image processing filters are selected for different parts of the intermediate image; and
apply the respective second image processing filters to the different parts of the intermediate image, to generate an output image.

14. The system of claim 12, wherein a first output of the analysis neural network comprises a pixel map that comprises, for a given pixel of the input image, a code that indicates a first image processing filter that is to be applied to the given pixel.

15. The system of claim 14, wherein the at least one processor is further configured to:
obtain information indicative of a gaze direction;
determine a given region of the input image, based on the gaze direction; and
select a first image processing filter to be applied to the given region, based on at least one of: (i) a code that is same for at least a predefined percent of pixels in the given region, (ii) weightages of respective codes of the pixels in the given region.
